(19) United States
(12) Patent Application Publication
(10) Pub. No.: US 2007/0010273 A1
(43) Pub. Date: Jan. 11, 2007

(54) Method and apparatus for operating a call service in a cellular communication system

(76) Inventors: Howard J. Thomas, Cirencester (GB); James P. Aldrich, Bartlett, IL (US); Edward M. Crane, Devizes (GB)

Correspondence Address: MOTOROLA, INC., 1303 EAST ALGONQUIN ROAD, IL01/3RD, SCHAUMBURG, IL, 60196, US

(21) Appl. No.: 11/178,740

(22) Filed: Jul. 11, 2005

(51) Int. Cl. H04B 7/00

(52) U.S. Cl. 455/519; 455/518

(57) ABSTRACT

A base station (105) comprises a notification processor (117) to transmit notification information of calls of a call service to remote terminals. The call service can be a GSM Voice Group Call Service (VGCS). The notification processor (117) comprises a BCCH processor (303) which notifies active calls for the call service to remote terminals in a first set of allocated radio blocks (201, 203) on a broadcast channel. A VGCS processor (307) determines that a new call is initialised, and in response the notification processor (117) replaces a notification for an existing call with a notification for the new call in at least one radio block of the first set of allocated radio blocks (201, 203).

### FIELD OF THE INVENTION

The invention relates to a method and apparatus for operating a call service in a cellular communication system and in particular, but not exclusively for a Global System for Mobile communications system.

### BACKGROUND OF THE INVENTION

In a cellular communication system a geographical region is divided into a number of cells each of which is served by a base station. The base stations are interconnected by a fixed network which can communicate data between the base stations. A mobile station is served via a radio communication link by the base station of the cell within which the mobile station is situated.

As a mobile station moves, it may move from the coverage of one base station to the coverage of another, i.e. from one cell to another. As the mobile station moves towards a base station, it enters a region of overlapping coverage of two base stations and within this overlap region it changes to be supported by the new base station. As the mobile station moves further into the new cell, it continues to be supported by the new base station. This is known as a handover or handoff of a mobile station between cells.

A typical cellular communication system extends coverage over typically an entire country and comprises hundreds or even thousands of cells supporting thousands or even millions of mobile stations. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition, the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication, etc.

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

3rd generation systems are currently being rolled out to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

Cellular communication systems tend to provide users with a number of different communication services. One such service is the Voice Group Call Service (VGCS) which has been specified for the GSM cellular communication system.

VGCS has been introduced to GSM to provide services and functionality suited for organisations or groups of users. Specifically, VGCS allows speech conversation for a predefined group of service subscribers using half duplex mode on the radio link. As such, VGCS may provide functionality typically known from private land mobile radio communication systems and may be particularly interesting for closed user groups such as a service organisation or an emergency organisation.

A VGCS user may have a given group identity allocation and may be allowed to take part in communications for that specific group identity. In order to allow terminals to detect that a VGCS group call is currently active for the specific group, the GSM recommendations provide for notifications of active calls to be transmitted on a Notification CHannel (NCH) on the Broadcast Control CHannel (BCCH). Specifically, a number of radio blocks are allocated on the BCCH to provide information of active VGCS calls, and the VGCS mobile stations monitor these to detect if a group call for their group is active.

Furthermore, in order to provide a flexible utilisation of the limited resource on the BCCH, the number and location of radio blocks used for VGCS notification may be dynamically varied in response to the requirement for notification and specifically in response to the number of active VGCS calls. Accordingly, the GSM recommendations provide for mobile stations to be informed of the NCH configuration via broadcast information and in particular via broadcasting of System Information type 1 (SI1) messages.

However, the GSM recommendations only require mobile stations to decode this message every thirty seconds, and accordingly, a significant delay may be incurred in the mobile stations adapting to any reconfiguration of the NCH. For example, if a new VGCS call is initialized which cannot be notified within the currently allocated radio blocks, the notification may occur in new radio blocks allocated to the NCH. These new radio blocks will be identified in the SI1 message, but as the delay before the mobile stations may receive this reconfiguration information can be up to thirty seconds, the remote terminal will not be able to receive notification of the presence of new VGCS calls for up to about thirty seconds. This delay is very significant and may result in a very slow call initialization or in some users potentially missing information communicated at the start of a call. For example, for an emergency group call, it is unacceptable that the delay, before it is guaranteed that all mobile stations can receive the call, is thirty seconds.

Hence, an improved system of operating a call service in a cellular communication system would be advantageous and in particular a system allowing increased flexibility, reduced delay, improved performance and/or an improved user service would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for operating a call service in a cellular communication system, the apparatus comprising: means for notifying active calls for the call service to remote terminals in a first set of allocated radio blocks on a broadcast channel; means for determining that a new call is initialised; and means for replacing a notification for an existing call with a notification for the new call in at least one radio block of the first set of allocated radio blocks.

The delay associated with conventional call services, such as GSM VGCS, can be reduced. This delay may be reduced by using a more flexible and dynamic usage of already allocated radio blocks to reduce delays when setting up a new call. Notification of a new call at the expense of an existing call can provide improved performance.

The invention can reduce the delay associated with new calls for a call service wherein active calls are notified. An improved user experience and/or improved performance of the call service can be achieved. In particular, the invention can allow an improved performance by a dynamic selection of which active calls to notify.

The means for notifying active calls can specifically notify the active calls to remote terminals of the cellular communication system. The broadcast channel can specifically be an air interface broadcast channel of the cellular communication system. The means for notifying active calls can notify all active calls for the call service or only notify a subset of active calls for the call service. The notification of the existing call is allocated for notification in the first set of allocated radio blocks. The first set of allocated radio blocks may further be allocated to notifications of other active calls. The first set of radio blocks may comprise one or more radio blocks.

According to an optional feature of the invention, the call service is a voice group call service.

The invention allows an improved voice group call service and can in particular reduce delays for new calls.

According to an optional feature of the invention, the apparatus further comprises means for allocating a second set of radio blocks for notifying active calls in response to the initialisation of the new call.

This allows the allocation of radio blocks to be dynamically adjusted to match the current requirements. The second set of radio blocks can comprise one or more radio blocks.

According to an optional feature of the invention, the means for notifying is arranged to notify the existing call in the second set of radio blocks.

This allows improved performance and can in particular allow that both the new and existing call is notified while reducing the delay for the new call. In particular, the inventors have realised that the notification of the new call to remote terminals having only knowledge of the first set of radio blocks can be achieved while also allowing all calls to be notified to remote terminals having knowledge of both the first and second set of radio blocks.

According to an optional feature of the invention, the means for notifying is arranged to alternately notify the new call in the first and second set of radio blocks.

This allows improved performance and can reduce delay for a new call while allowing other calls to be notified in the first set of radio blocks. The new call can be alternately notified in the first and second set in accordance with any suitable sequence or algorithm for selecting which set of radio blocks to notify in. The means for notifying can be arranged to notify the new call alternatively in the first and second set of radio blocks after which the notification may be only in the first or second set of radio blocks.

According to an optional feature of the invention, the means for notifying is arranged to alternately notify the existing call in the first and second set of radio blocks.

This allows improved performance and can reduce delay for a new call while allowing the existing call to still be notified to remote terminals having knowledge only of the first set of radio blocks. The existing call may be alternately notified in the first and second set in accordance with any suitable sequence or algorithm for selecting which set of radio blocks to notify in. The means for notifying can be arranged to notify the existing call alternatively in the first and second set of radio blocks after which the notification can be only in the first or second set of radio blocks.

According to an optional feature of the invention, the apparatus further comprises means for broadcasting information of the allocation of radio blocks for notifying active calls.

This allows improved performance and can allow remote terminals to determine the radio blocks to monitor for notifications. In particular, the means for broadcasting information can broadcast information indicating that a new set of radio blocks may be used for call notification.

According to an optional feature of the invention, the means for replacing is arranged to select between notifying the existing call and the new call in the first set of allocated radio blocks in response to a relative priority of the existing call and the new call.

This allows improved performance and operation and can in particular provide an improved trade off between the impact of reduced notifications for the existing call and the new call. For example, an emergency call may be considered of a higher priority than a non-emergency call, and the apparatus can be arranged to prioritise the notification of an emergency call in the first set of radio blocks in preference to a non-emergency call.

According to an optional feature of the invention, the means for replacing is arranged to replace the notification for the existing call with the notification for the new call if the new call is an emergency call.

This allows improved performance and can in particular reduce delays for emergency calls while reducing the impact on existing calls. If the new call is not an emergency call, any other criterion or algorithm for selecting whether to replace the notification of the existing call with a notification of the new call may be used.

According to an optional feature of the invention, the notification for the new call comprises an identification of at least one transmission parameter for the new call. This provides for improved operation.

According to an optional feature of the invention, the cellular communication system is a GSM communication system and in particular the call service is a Voice Group Call Service in accordance with the GSM Recommendations.

The invention allows improved performance and operation, and in particular reduced delays for new calls of a GSM Voice Group Call Service.

According to an optional feature of the invention, the broadcast channel is a Broadcast Control CHannel (BCCH). The invention may allow improved performance for a GSM call service using the BCCH for call notifications of active calls.

According to a second aspect of the invention, there is provided a cellular communication system comprising: means for supporting a call service; means for notifying active calls for the call service to remote terminals in a first set of allocated radio blocks on a broadcast channel; means for determining that a new call is initialised; and means for replacing a notification for an existing call with a notification for the new call in at least one radio block of the first set of allocated radio blocks.

According to a third aspect of the invention, there is provided a method of operating a call service in a cellular communication system, the method comprising: notifying active calls for the call service to remote terminals in a first set of allocated radio blocks on a broadcast channel; determining that a new call is initialised; and replacing a notification for an existing call with a notification for the new call in at least one radio block of the first set of allocated radio blocks.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in which embodiments of the invention can be employed;

FIG. 2 illustrates an example of a broadcast channel supporting a notification channel for a voice group call service;

FIG. 3 illustrates an example of an apparatus for operating a call service in a cellular communication system in accordance with some embodiments of the invention;

FIG. 4 illustrates an example of a broadcast channel supporting a notification channel for a voice group call service; and

FIG. 5 illustrates an example of a method of operating a call service in a cellular communication system in accordance with some embodiments of the invention.

### DETAILED DESCRIPTION OF SOME EMBODIMENTS OF THE INVENTION

The following description focuses on embodiments of the invention applicable to a GSM cellular communication system and in particular to a GSM cellular communication system supporting GSM Voice Group Call Services (VGCS's). However, it will be appreciated that the invention is not limited to this application but can be applied to many other cellular communication systems and call services including for example 3^{rd} generation cellular communication systems.

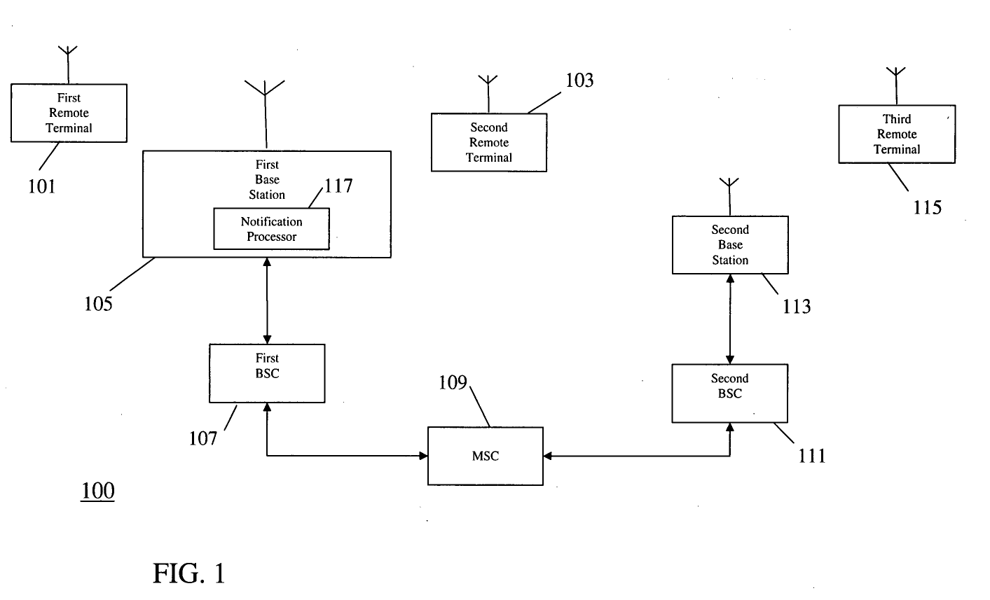

FIG. 1 illustrates an example of a cellular communication system 100 in which embodiments of the invention can be employed.

In the example of FIG. 1, a first remote terminal 101 and a second remote terminal 103 are in a first cell supported by a first base station 105.

A remote terminal can for example be user equipment such as a 3^{rd} Generation User Equipment (UE), a communication unit, a subscriber unit, a mobile station, a communication terminal, a personal digital assistant, a laptop computer, an embedded communication processor or any physical, functional or logical communication element which is capable of communicating over the air interface of the cellular communication system.

The first base station 105 is coupled to a first Base Station Controller (BSC) 107. A BSC performs many of the control functions related to the air interface including radio resource management and routing of data to and from appropriate base stations.

The first BSC 107 is coupled to a Master Switch Centre (MSC) 109. An MSC interconnects BSCs and is operable to route data between any two BSCs, thereby enabling a remote terminal in a cell to communicate with a remote terminal in any other cell. In addition, the MSC 109 can comprise gateway functions for interconnecting to external networks such as the Public Switched Telephone Network (PSTN), thereby allowing remote terminals to communicate with landline telephones and other communication terminals connected by a landline.

It will be appreciated that the cellular communication system comprises functionality for managing a conventional cellular communication network including functionality for routing data, admission control, resource allocation, subscriber billing, remote terminal authentication, and the like, which will be well known to the person skilled in the art and need not be described further herein.

The MSC 109 is further coupled to a second BSC 111 which is coupled to a second base station 113. The second base station 113 supports a third remote terminal 115.

The system 100 of FIG. 1 supports VGCS and in the specific example the three remote terminals 101, 103, 115 are all part of the same call group. In order to support the VGCS operation, the first base station 105 and the second base station 115 broadcast information of which VGCS calls are currently active. The information is transmitted in a Notification CHannel (NCH) which is carried by the Broadcast Control CHannel (BCCH).

Each base station 105, 113 transmits the notifications of active VGCS calls with the base stations 105, 113 individually arranging and controlling how the NCH is configured on the BCCH of the specific cell.

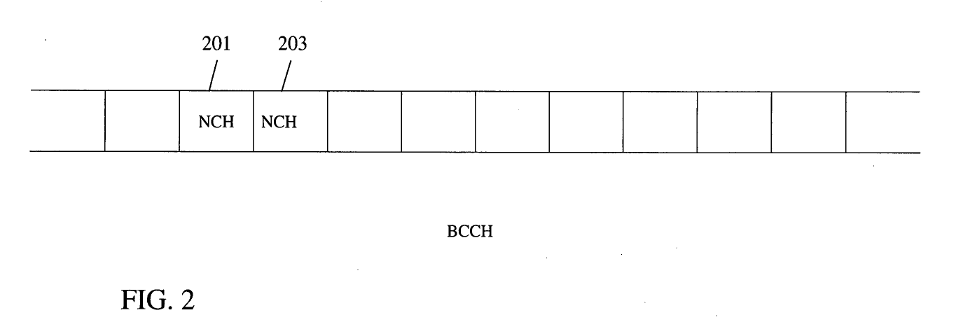

FIG. 2 illustrates an example of a BCCH supporting an NCH for a VGCS. The BCCH is divided into a number of radio blocks corresponding to individual timeslots on the BCCH. In the specific example, two radio blocks 201, 203 are allocated to an NCH. Thus, the information of the currently active VGCS services is transmitted in the two radio blocks 201, 203 which specifically can comprise information of the frequencies and time slots used for the individual VGCS call.

As the NCH may be allocated to different BCCH radio blocks in different cells, the individual base stations 105, 113 furthermore transmit information of the transmission details of the NCH and specifically of which radio blocks support the NCH. This information is transmitted in System Information Type 1 (S11) messages.

Accordingly, a VGCS remote terminal will receive the SI1 messages from the serving base station and will use the received information to monitor the radio blocks forming the NCH in the specific cell.

Thus, for example, if the first remote terminal 101 initiates a group call, the NCH of the first base station 105 and the second base station 113 will transmit a notification of the group call on the NCH of their respective BCCHs. The second remote terminal 103 and the third remote terminal 115 will monitor the NCH of the first base station 105 and the second base station 113 respectively and will thus detect that a group call is active for their VGCS group. Accordingly, the remote terminal may use the received information to tune to the specified frequency and time slot and join the group call.

However, in situations where the allocated radio blocks for the NCH are fully occupied by information relating to ongoing VGCS calls, the NCH cannot support a new active VGCS call being initialised. Conventionally, this problem is solved by a reconfiguration of the NCH to include additional radio blocks carrying the information for the new active calls. The reconfiguration information for the NCH is transmitted in SI1 messages, and when these are received, the remote terminals start monitoring the additional radio blocks thereby allowing the remote terminal to detect the new active call.

However, the GSM Recommendations only require the remote terminals to receive S11 messages at thirty second intervals. Thus, the remote terminals may not receive information of the reconfiguration of the NCH for up to thirty seconds and may accordingly not be able to receive notification of the new VGCS calls for thirty seconds. This delay is highly undesirable and provides a significant disadvantage to VGCS users. For example, if a user makes an emergency VGCS call, he cannot assume that this is received by other members of the VGCS group for an initial thirty seconds.

The system of FIG. 1 can provide improved performance.

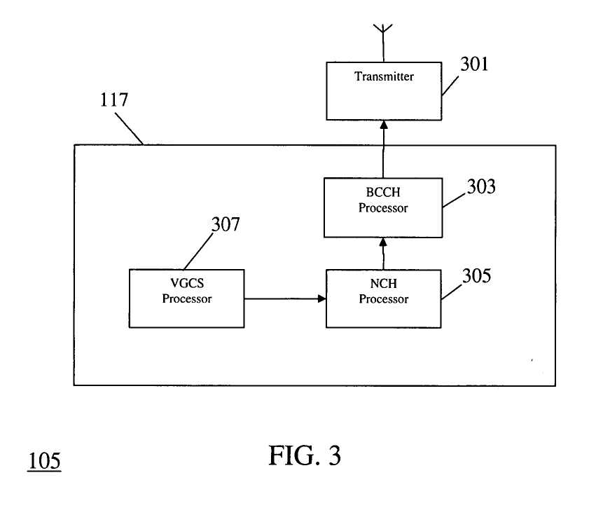

In the example of FIG. 1 the first base station 105 comprises a notification processor 117 which is arranged to control and operate the notification of the VGCS information. FIG. 3 illustrates the first base station 105 and the notification processor 117 in more detail.

The first base station 105 comprises a transmitter 301 which is arranged to transmit signals over the air interface of the GSM cellular communication system. In particular, the transmitter 301 is arranged to broadcast the BCCH to remote terminals in the cell.

The transmitter 301 is coupled to a BCCH processor 303 which is arranged to generate the BCCH data for transmission by the transmitter 301. In particular, the BCCH processor 303 is arranged to include the NCH radio blocks containing notification of active VGCS calls in the BCCH. Thus, the BCCH processor 303 provides a notification in a first set of allocated radio blocks (one or more) on the BCCH broadcast channel. In the specific example, the BCCH processor 303 may include the notifications in the radio blocks 201, 203 forming the NCH of FIG. 2.

The BCCH processor 303 is coupled to an NCH processor 305 which is arranged to generate the NCH information. Thus, the NCH processor 305 stores information of the currently active VGCS calls and structures this for the NCH radio blocks 201, 203 in accordance with the requirements of the GSM Recommendations.

The notification processor 117 furthermore includes a VGCS processor 307 which is arranged to detect when new VGCS calls are set up or terminated. Thus, the VGCS processor 307 is in particular arranged to determine that a new call is initialised. The VGCS processor 307 may for example determine this in response to the information received from the BSC. The management of the establishment of a new VGCS call is managed by the MSC which informs the various BSCs in the system. The BSCs can then inform the BTS thus providing the individual BTS with information of the setup of a new VGCS.

When the VGCS processor 307 determines that a new VGCS call is initialised, it provides information of all the required transmission parameters to the NCH processor 305. For example, the NCH may indicate the VGCS group identity, the allocated carrier frequency and the allocated time slot number. In response, the NCH processor 305 includes this information in the NCH radio blocks.

In particular, the NCH processor 305 is arranged to replace a notification for an existing call with a notification for the new call in the radio blocks of the first set of allocated radio blocks 201, 203. Thus, the NCH processor 305 can remove the information for an existing call in the radio blocks 201, 203 and instead insert the information for the newly initialised call.

Accordingly, the remote terminals monitoring the NCH will immediately be informed of the new call being setup, and the notification of a new call is not restricted by the potential requirement for a reconfiguration of the NCH with a subsequent delay incurred by the SI1 message communication.

For example, if the notification of the currently active calls fully uses up the data capacity of the radio blocks 201, 203 allocated to the NCH, the new call can still be notified in these radio blocks without any additional delay or reconfiguration. Thus, the remote terminals can join the new VGCS call with much reduced delay and the call setup delay can be reduced substantially. Thus, a much improved VGCS service is achieved.

Although the removal of information for a given existing VGCS call will result in the remote terminals not being notified of this call in the current transmission(s) of the NCH radio blocks, this information will typically already have been received by the remote terminals. Thus, typically, no detrimental effect is caused by the replacement as remote terminals desiring to join the existing VGCS call would already have done so.

Furthermore, the replacement of data may not always be performed. For example, when a new VGCS call initialisation is detected, the NCH processor 305 can determine if there is currently available resource in the assigned radio blocks 201, 203 for including this information in addition to the information for the previously active calls. If so, the NCH processor 305 will simply add the notification of the new call to the existing notifications. However, if no resource is available, the NCH processor 305 can proceed to replace the notification of an existing call with the notification of the new call thereby reducing the call setup delay substantially.

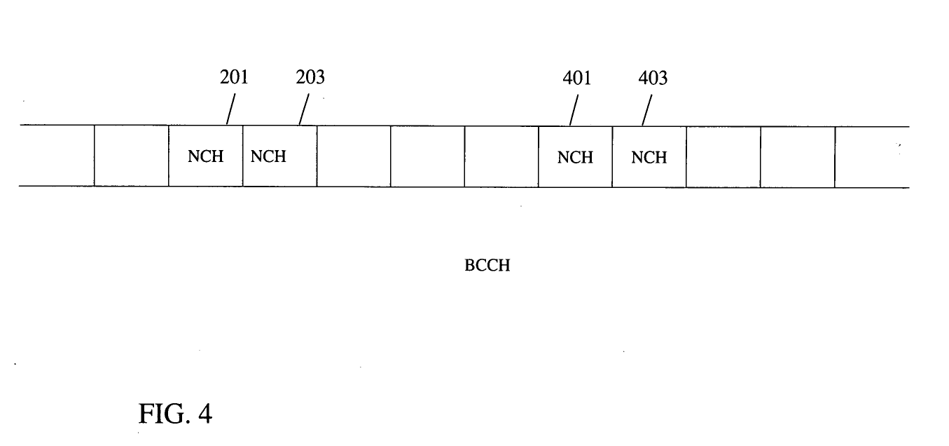

Furthermore, if the current allocation of radio blocks 201, 203 is insufficient to carry notification data for both the existing calls and the new calls, the NCH processor 305 can reconfigure the NCH to include additional radio blocks. Specifically, the NCH processor 305 can allocate a second set of radio blocks of the BCCH to the NCH. FIG. 4 illustrates an example of the BCCH following such a reconfiguration. In the specific example, two more radio blocks 401, 403 are additionally allocated to the NCH.

However, rather than merely including the notification for the new call in the second set of radio blocks 401, 403, the NCH processor 305 proceeds to replace the information of an existing call in the first set of radio blocks. Furthermore, the NCH processor 305 may proceed to include the notification for the replaced existing call in the second set of radio blocks 401, 403.

The NCH processor 305 can then proceed to generate SI1 messages which are transmitted to the remote terminals. Thus, as and when the remote terminals receive the SI1 messages, they will begin to monitor all radio blocks of the reconfigured NCH and will thus receive notifications of all VGCS calls.

In the example, rather than incurring a call setup delay of up to thirty seconds, the delay for remote terminals being able to join a new VGCS call may be reduced substantially (typically to less than one second).

Although this can be achieved at the expense of remote terminals not being provided with notifications of an existing call for a duration of up to thirty seconds, a notification pause is generally much less significant during a call than at the initialisation of a call. Thus, a much improved VGCS performance can be achieved by the described exemplary system.

In some embodiments, the NCH processor 305 may be arranged to alternately notify the new call and/or the existing call in the first and second set of radio blocks. For example, in one frame, the new call can be notified in radio block 201 and the existing call in radio block 401 (see FIG. 4). In the following frame, the existing call may be notified in radio block 201 and the new call in radio block 401. This can allow a remote terminal monitoring only the first set of radio blocks 201, 203 to be notified of both the existing as well as the new call without waiting for it to receive any SI1 reconfiguration messages. At the same time, any remote terminal having reconfigured itself to monitor both the first set of radio blocks 201, 203 and the second set of radio blocks 401, 403 can receive notifications of all active VGCS calls in each frame.

It will be appreciated that any sequence or algorithm for alternating the notification information may be used. For example, the first set of radio blocks can comprise notifications for the new call in two out of every three frames with the existing call being notified in the third frame. Furthermore, the alternating pattern can be dynamically changed so that for example the existing call is notified more frequently in the first set of radio blocks when the call is first initialised and then gradually less and less frequently during the next thirty to thirty-five seconds after which it may only be notified in the second set of radio blocks 401, 403.

Furthermore, in some embodiments, the NCH processor 305 is arranged to select between notifying the existing call and the new call in the first set of allocated radio blocks in response to a relative priority of the existing call and the new call.

For example, the NCH processor 305 can simply evaluate if the new call has a higher priority than the existing call and if so the notification of the existing call can be replaced by the notification of the new call. However, if the existing call has a higher priority, this can still be notified in the first set of radio blocks 201, 203 and no replacement can be made. If the two calls have an equal priority, the NCH processor 305 can alternate between the notifications in subsequent frames.

The priority of a call can be a predetermined/pre-allocated priority or can for example be determined from the type of call. For example, an emergency call can be considered of the highest priority whereas a non-emergency call can be considered of lower priority. Thus, applying the above described example, the NCH processor 305 can allow that an emergency call is always notified in preference to a non-emergency call.

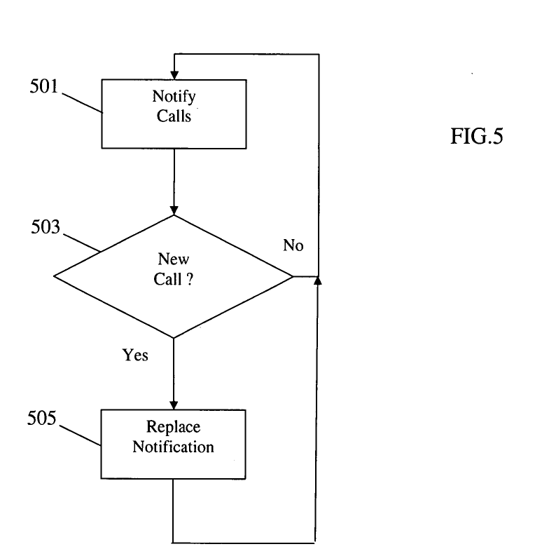

FIG. 5 illustrates an example of a method of operating a call service in a cellular communication system in accordance with some embodiments of the invention. The method can be applicable to the notification processor 117 of FIG. 3 and will be described with reference to this.

In step 501 the notification processor 117 controls the BCCH processor 303 to notify remote terminals of the active calls for the call service by transmitting notification information in a first set of allocated radio blocks 201, 203 on a broadcast channel.

In step 503 it is determined whether a new call is initialised. If not, the method returns to step 501.

Otherwise, the method proceeds to step 505 wherein the notification processor 117 replaces a notification for an existing call with a notification for the new call in the radio blocks of the first set of allocated radio blocks 201, 203. The method then returns to step 501.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second”, etc., do not preclude a plurality.

What is claimed is:

1. An apparatus for operating a call service in a cellular communication system, the apparatus comprising:
means for notifying active calls for the call service to remote terminals in a first set of allocated radio blocks on a broadcast channel;
means for determining that a new call is initialised; and
means for replacing a notification for an existing call with a notification for the new call in at least one radio block of the first set of allocated radio blocks.

2. The apparatus claimed in claim 1 wherein the call service is a voice group call service.

3. The apparatus claimed in claim 1 further comprising means for allocating a second set of radio blocks for notifying active calls in response to the initialisation of the new call.

4. The apparatus claimed in claim 3 wherein the means for notifying is arranged to notify the existing call in the second set of radio blocks.

5. The apparatus claimed in claim 3 wherein the means for notifying is arranged to alternately notify the new call in the first and second set of radio blocks.

6. The apparatus claimed in claim 3 wherein the means for notifying is arranged to alternately notify the existing call in the first and second set of radio blocks.

7. The apparatus claimed in claim 1 further comprising means for broadcasting information of the allocation of radio blocks for notifying active calls.

8. The apparatus claimed in claim 1 wherein the means for replacing is arranged to select between notifying the existing call and the new call in the first set of allocated radio blocks in response to a relative priority of the existing call and the new call.

9. The apparatus claimed in claim 1 wherein the means for replacing is arranged to replace the notification for the existing call with the notification for the new call if the new call is an emergency call.

10. The apparatus claimed in claim 1 wherein the notification for the new call comprises an identification of at least one transmission parameter for the new call.

11. The apparatus claimed in claim 1 wherein the cellular communication system is a GSM communication system.

12. The apparatus claimed in claim 11 wherein the call service is a Voice Group Call Service in accordance with the SM Recommendations.

13. The apparatus claimed in claim 11 wherein the broadcast channel is a Broadcast Control CHannel (BCCH).

14. A cellular communication system comprising:
means for supporting a call service;
means for notifying active calls for the call service to remote terminals in a first set of allocated radio blocks on a broadcast channel;
means for determining that a new call is initialised; and
means for replacing a notification for an existing call with a notification for the new call in at least one radio block of the first set of allocated radio blocks.

15. A method of operating a call service in a cellular communication system, the method comprising:
notifying active calls for the call service to remote terminals in a first set of allocated radio blocks on a broadcast channel;
determining that a new call is initialised; and
replacing a notification for an existing call with a notification for the new call in at least one radio block of the first set of allocated radio blocks.
